(19) United States
(12) Patent Application Publication
(10) Pub. No.: US 2002/0090904 A1
(43) Pub. Date: Jul. 11, 2002

(54) Method and apparatus for rinsing the body cavity of slaughtered poultry

(75) Inventors: Edward Johannes Tieleman, 'S-Gravenvoeren (BE); Franciscus Theodorus Peter Verhaegh, Doesburg (NL)

Correspondence Address: YOUNG & THOMPSON, 745 SOUTH 23RD STREET 2ND FLOOR, ARLINGTON, VA, 22202

(73) Assignee: TIELEMAN FOOD EQUIPMENT B.V., DOESBURG (NL)

(21) Appl. No.: 10/040,363

(22) Filed: Jan. 9, 2002

(30) Foreign Application Priority Data
Jan. 9, 2001 (NL) 1017057

(51) Int. Cl. A22B 7/00

(52) U.S. Cl. 452/173

(57) ABSTRACT

The present invention relates to a method for rinsing the body cavity of slaughtered poultry, such as a slaughtered chicken, wherein, after removing the innards from the bird, a finger is inserted in the body cavity, rinsing agent is introduced via the finger into the body cavity for rinsing said body cavity and the finger is removed from the body cavity. The invention also provides an apparatus as means for performing the method described above. The method in the apparatus is characterized in that before and/or during rinsing of the body cavity the skin between the legs of the bird, at the anal end of the body cavity, is moved away from the wall of the body cavity.

The present invention relates to a method and apparatus for rinsing the body cavity of slaughtered poultry, such as a slaughtered chicken, wherein, after removing the innards from the bird, a finger is inserted in the body cavity, rinsing agent is introduced via the finger into the body cavity for rinsing said body cavity and the finger is removed from the body cavity.

In the state of the art it is known to process slaughtered poultry, such as slaughtered chickens, in highly automated machines, The slaughtered chickens are hung on a hook or in a clamp with the aid of the feet. Consequently, the chickens hang essentially in a vertical position, the anus of the chicken facing upwards. The chicken is fed along various processing machines in this position, during which, inter alia, the head of the chicken is cut off and the innards are removed from the chicken. Finally the trunk of the chicken remains, with the thighs and optionally part of the wings thereon. In his stage the chicken is also referred to as “ready to cook”.

The ready-to-cook product can then be cooled and frozen. The ready-to-cook product is then sold as a single item. It is also possible that the ready-to-cook chicken is cut into portions with the aid of fit-her processing machines.

Before a ready-to-cook chicken can be further processed either by freezing the chicken or by cutting it into portions, the body cavity of the chicken has to be rinsed clean. The body cavity of a chicken is rinsed clean with the aid of water and/or a cleaning agent that has a disinfectant action and that must inhibit bacterial growth for further processing of the chicken it is essential that the cleaning agent comes into contact with essentially the entire surface of the wall of the body cavity.

When the innards are removed from the body cavity of the chicken an incision is made in the anus end of the chicken. Various processing elements then enter the body cavity of the chicken via the opening that has been made, in order to remove the innards from the body cavity. As a result of making the incision, there is a piece of skin, with fat underneath it, at the level of the anus, between the legs of the chicken, which piece of skin hangs essentially vertically downwards under the influence of gravity. The inside of this skin/fat hangs in contact with the inside wall of the body cavity, close to the anal opening, under the influence of gravity.

At the point in time when it is desired to rinse the body cavity with rinsing agent, the skin/fat described above will cover part of the inside wall of the body cavity. This means that the rinsing agent is not able to reach this part of the body cavity and that bacterial growth can occur at precisely this location during further processing of the chicken.

The aim of the present invention is, in the light of the above, to provide a method and an apparatus with which essentially the entire wall of the body cavity of slaughtered poultry, such as a slaughtered chicken, can be cleaned with the aid of rinsing agent.

Said aim is achieved according to the present invention in that before and/or during rinsing of the body cavity the skin/fat between the legs of the bird, at the anal end of the body cavity, is moved away from the wall of the body cavity.

This measure is achieved in that the skin/fat is first moved away, so that the inside wall of the body cavity is accessible for spraying the wall of said body cavity with the rinsing agent. That is to say the entire inside wall of the body cavity of the chicken can be cleaned with he aid of the rinsing agent.

According to the invention it is advantageous that the bird is hung essentially vertically before the body cavity thereof is rinsed.

According to the invention it is possible that a member is moved in the body cavity underneath the skin between the legs of the bird, after which the member is moved upwards over a distance such hat the skin is essentially moved away from the wall of the body cavity.

The skin/fat will rest against the inside wall of the body cavity, at the level of the anus of the chicken, under the influence of gravity. With the aid of a member it is possible to reach beneath the skin/fat in order to move the skin/fat upwards it the action of gravity, in order to expose the inside wall of the body cavity.

According to the invention it is possible that the member is fixed to the finger for introducing rinsing agent into the body cavity.

Before rinsing the body cavity a finger has to be introduced into the body cavity. This finger will have been provided with a nozzle from which rinsing agent can be sprayed. Since it is necessary to move this finger in the body cavity, it is advantageous to fix the member with the aid of which the skin/fat is moved aside to this finger. That is to say, the introduction and the movement of the member does not require any additional operations.

According to the invention it is possible that, before rinsing, the vertical position of the bird is adjusted by pushing the bird with the aid of a pusher.

By pushing against the chicken on the outside, the chicken can be positioned such that the skin/fat can be adequately engaged with the aid of the member in order adequately to expose the inside wall of the body cavity.

As an alternative, it is also possible that the bird is rotated from an equlibrium position towards a first side in order to position a first portion of the skin/fat above the member and that the member is then lifted, after which the bird is rotated towards a second side in order to position a second portion of the skin/fat above the second member, after which the member is moved upwards.

By allowing the chicken to rotate in a first direction, the skin/fat will move relative to the inside wall of the body cavity. As a result a first portion, for example the portion close to the left leg of the chicken, can be positioned above the member in the body cavity. The member can then be moved upwards so that the left-hand portion of the skin/fat is hanging directly above the member. The member is then moved upwards and the body cavity of the chicken can be sprayed clean with the aid of the spray head. The member is then moved down again, so that the skin/fat again hangs free. The chicken is then allowed to rotate into a second position, the portion of the skin/fat close to the right leg hanging above the member. The member can then be moved up, so that the right-hand portion of the skin/fat is hanging directly above the member at the point in time when the member is moved upwards. The body cavity of the chicken can then again be sprayed clean with the aid of the spray head. In this way the wall of the body cavity is sprayed clean stepwise.

It is clear that the two methods described above can also be mechanically reversed That is to say, the chicken is allowed to hang in the equilibrium position thereof and the finger is then allowed to move back and forth in order to achieve essentially the same effect.

As an alternative, it is possible that, after introducing the finger, the cross-section of essentially the end of the finger is allowed to increase in order to engage the bottom of the skin, after which the finger is moved upwards somewhat, before and/or during rinsing of the body cavity, in order to move the skin away from the wall of the body cavity.

According to the invention it is possible that, before and/or during rinsing, the skin between the legs of the bird is moved away from the wall of the body cavity by rotating the bird from the essentially vertical position into an essentially horizontal position, the skin coming away from the wall of the body cavity under the influence of gravity.

According to this variant, a member is not used to cause the skin/fat to move relative to the wall of the body cavity, but gravity is used for moving the skin/fat relative to the inside wall of th body cavity. By rotating the chicken into a position in which the body cavity in principle extends in the horizontal direction, the skin/fat will come away from the wall of the body cavity of the chicken under the influence of gravity. By this means rinsing agent is able to clean the entire wall of the body cavity by an alternative procedure.

According to the invention it is advantageous to allow the bird to rotate into the horizontal position thereof, for example with the aid of a rail.

In addition to the method that has been described above, the invention also relates to an apparatus for rinsing the body cavity of a slaughtered bird, such as a slaughtered chicken, provided with a transport device for moving the chicken, which transport device is provided with hooks for engaging the legs of the bird, and a finger that is provided with a spray head, which finger is suitable for inserting in the body cavity of the bird in order to rinse the body cavity of the bird by means of the spray head of the finger. The apparatus according to the invention is characterised in that the apparatus comprises means for causing the skin/fat between the legs of the slaughtered bird, at the anal end of the body cavity thereof, to move away from the wall of the body cavity.

According to a preferred embodiment, it is possible that the means for causing the skin/fat of the bird to move away from the wall of the body cavity comprise a member for engaging under the skin/fat of the bird and moving said skin/fat essentially in the vertical direction.

With this arrangement it is possible that the member for moving the skin/fat away from the wall of the body cavity is fixed to the finger for rinsing the body cavity.

In order to rinse the body cavity of a bird, such as, for example, a chicken first of all a finger is placed in the body cavity. An injection nozzle will be fixed to this finger, in order to rinse the body cavity of the bird with the aid thereof. In view of the fact that this finger has to be moved in the body cavity in any case, it is advantageous also to fix the member for manipulating the skin/fat to this finger. It is possible that the finger is introduced into the body cavity via the anus and the finger is then lifted upwards in order to manipulate the skin/fat with the aid of the member that is fixed to the finger. What is achieved by controlling the movement of the finger is that the injection nozzle on the finger is positioned in the body cavity of the chicken and, moreover, the skin/fat is moved into the correct position with the aid of the member.

According to the invention it is furthermore possible that the member for engaging the skin/fat can be folded out from a first folded-up position into a second folded-out position, the cross-section of the member in the folded-out position being greater than that in the folded-up position thereof.

Furthermore, it is possible that the apparatus comprises a pusher for engaging on the outside wall of the bird for positioning the skin above the member for moving the skin

With the aid of the pusher, the skin/fat can be so positioned that this can easily be engaged by the member in order essentially to expose the inside wall of the body cavity.

As an alternative it is possible that the apparatus comprises means for rotating the bird from an essentially vertical equilibrium position in order, by means of said rotation, to position, respectively, a first and a second portion of the skin/fat of the bird above the member.

By moving the chicken back and forth the skin/fat can be positioned directly above the member, so that it is ensured that the skin/fat can be readily engaged by the member at the point in time when the member is moved upwards.

It is also possible mechanically to reverse this movement, it being possible to move the member to position the member under, respectively, a first and a second portion of the skin/fat of the bird.

According to the invention it is furthermore possible that the movement of the means for causing the skin/fat to move away from the wall of the body cavity are coupled to the transport device in such a way that the means are actuated during the transport of the bird by the device.

In order to rinse a body cavity of a chicken it is possible to allow a finger to move up and down in the body cavity in order to obtain a good distribution of the rinsing agent that is injected into the body cavity with the aid of the injection head on the finger. By controlling this up and down movement in the correct manner, the member can be moved to the bottom of the skin/fat with the first downward movement. The skin/fat can be lifted somewhat with the first upward movement.

The present invention will be further described with reference to the appended figures, in which:

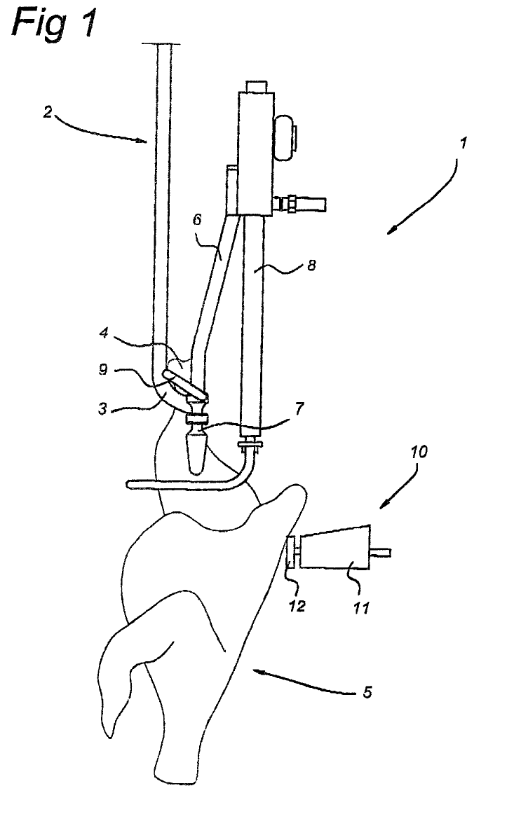

FIG. 1 shows a diagrammatic side view of the apparatus according to the invention.

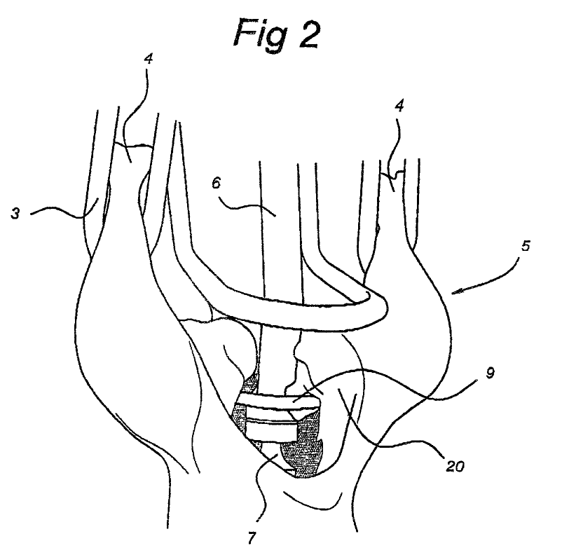

FIG. 2 shows a perspective view of a finger with, thereon, an injection nozzle that is moved in the body cavity of a chicken.

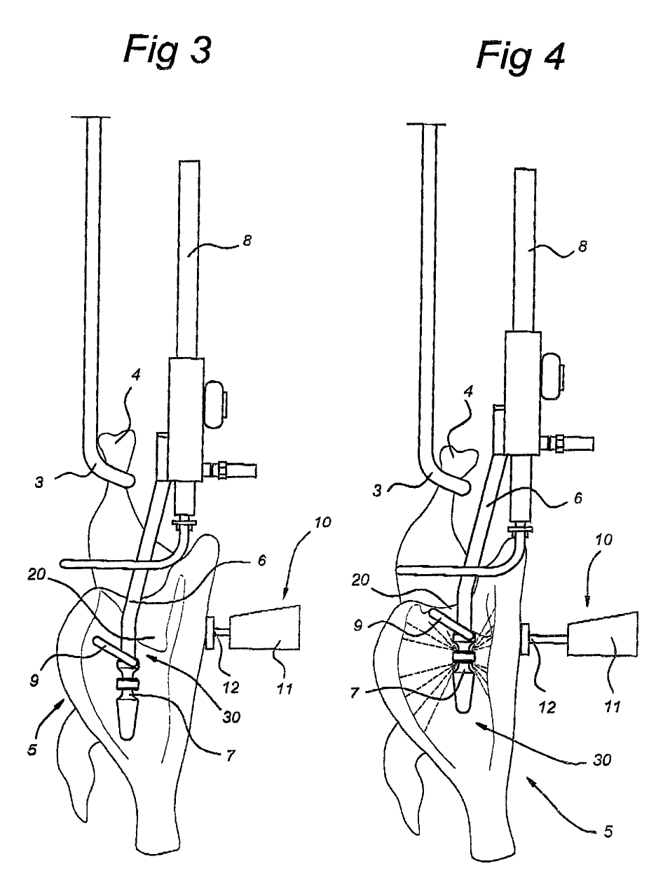

FIG. 3 shows a view according to FIG. 1, where the chicken is shown partially in section and where the finger has been moved to the bottom of the body cavity, before spraying.

FIG. 4 shows a side view according to FIG. 3, where the finger has been lifted somewhat in order to move the skin/fat upwards during rinsing.

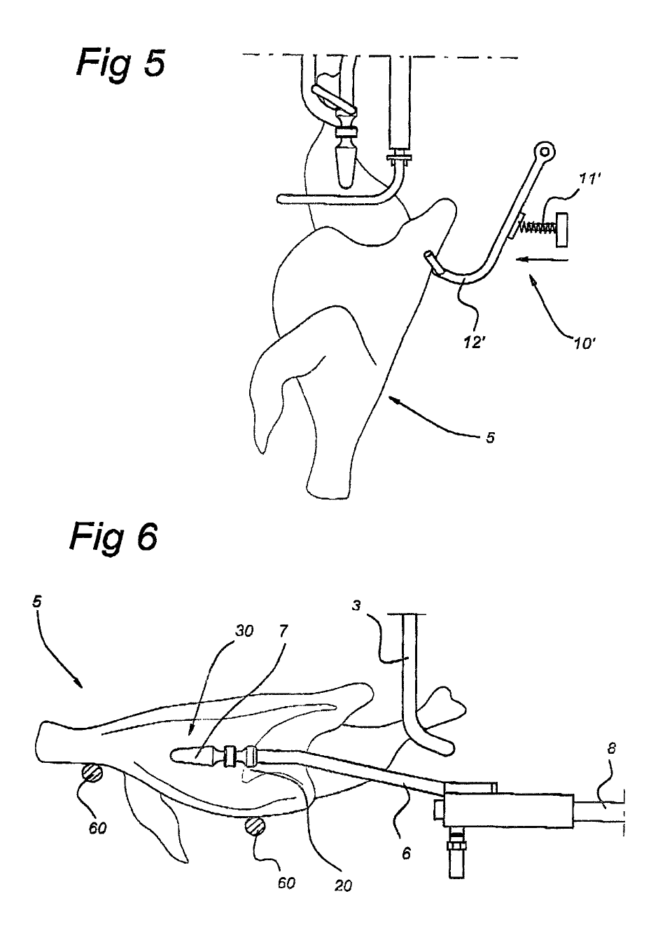

FIG. 5 shows a side view according to FIG. 1, with a pusher on the outside wall of the chicken.

FIG. 6 shows a side view, partially in section, of a chicken that has been rotated in such a way that the body cavity extends essentially in the horizontal direction.

The apparatus 1 according to the present invention for rinsing the body cavity of poultry is shown in FIG. 1. The apparatus 1 firstly comprises a hook 2, that is provided at the bottom with two stirrups 3, in which the legs 4 of a chicken 5 have been secured. The hook 2 is known from the state of the art and is used in order to move the chicken 5 along a number of processing machines, which processing machines are used for, inter alia, removal of the innards from the body cavity of the chicken 5. Apparatus 1 further comprises a finger 6, the end 7 of which is provided with an injection head for spraying rinsing agent. The finger 6 can be moved in the vertical direction along a guide 8. As the finger is moved further downwards, this results in the injection head 7 being moved into the body cavity of the chicken 5. A member 9 is also fixed to the finger 6. This member 9 is used to move the skin/fat, that is hanging free between the legs of the chicken 5, in the vertical direction. The mode of action of the member 9 will be further explained with reference to FIGS. 2, 3 and 4. A pusher device 10 is also shown in FIG. 1. This device comprises a stationary part 11, that, for example, is fixed to a permanent structure, and a movably fitted element 12, that can be moved in the horizontal direction with respect to the part 11. The function of the pusher will be explained with reference to FIGS. 3 and 4.

In FIG. 2 part of the chicken 5 is shown in perspective, the legs 4 of which chicken 5 have been hooked into the stirrups 3. It can be seen in FIG. 2 that skin/fat 20 is present between the legs 4, at the anal inlet to the body cavity in the chicken 5, which skin/fat 20 can start to hang down under the influence of gravity and thus can cover a portion of the inside of the body cavity of the chicken. If the skin/fat 20 does indeed hang down, cleaning of the body cavity with the aid of a rinsing agent will not be able to take place in an optimum manner because a portion of the wall of the body cavity is shielded. According to the invention, the skin/fat 20 can be moved vertically upwards with the aid of the member 9 before rinsing. As a result of moving the skin/fat 20 upwards the inside wall of the body cavity that was covered by the skin/fat 20 is exposed. That is to say, during rinsing with the aid of a rinsing head 7 this portion of the inside wall of the body cavity can also be reached with the aid of the rinsing agent and consequently can be cleaned. The positioning of the member 9 under the skin/fat 20 is further explained with reference to FIGS. 3 and 4. In FIG. 3 the chicken 5 is shown partially in section and it can be seen that the finger 6 is moved downwards in the vertical direction in such a way that the rising head 7 is essentially within the body cavity 30 in the chicken 5. It can also be seen in FIG. 3 that the skin/fat 20 hangs down under the influence of gravity, so that at least a portion of the inside wall of the body cavity 30 is covered by this skin/fat.

Before rinsing with the aid of a rinsing head 7, the finger 6 is moved up along the vertical guide 8. This can be seen in FIG. 4. Because the finger 6 has been moved upwards, the member 9 will also move upwards and thus force the skin/fat 20 upwards in the vertical direction. As a result the inside wall of the body cavity 30 is also exposed at the location of the skin/fat 20, so that the inside wall of the body cavity can also be cleaned at this location. Spraying of the body cavity 30 of the chicken 5 is indicated diagrammatically with the aid of the broken lines in FIG. 4. In order to ensure that the member 9 comes under the skin/fat 20 in the correct manner, the position of the chicken 5 with respect to the vertical plane can be influenced with the aid of the element 12 of the pusher device 10. By pushing the element 12 out in the correct manner the vertical position of the chicken 5 can be so adjusted that the skin/fat is reliably present above the member 9 at a point in time when the member is moved upwards.

An alternative embodiment of the pusher device 10′ is shown in FIG. 5. Pusher device 10′ comprises an element 12′ that is constructed as a forks. The end of the fork is curved somewhat in order to engage over a relatively large surface of the outside wall of the chicken 5 and to keep the pressure on the outside wall of the chicken 5 low. The device 10′ according to FIG. 5 also comprises an element 11 that makes contact with a permanent structure.

According to FIG. 6 an alternative method is shown for exposing the inside wall of the body cavity of a chicken 5. According to FIG. 6 the position of the chicken 5 is so rotated that the body cavity 30 extends essentially in the horizontal direction. Rotation of the chicken 30 can, for example, take place with the aid of a rail 60, that is shown in cross-section. The chicken 5 will be guided over the rail 60 from an essentially vertical position into the essentially horizontal position that is shown in FIG. 6. As a result of this position, the skin/fat 20 will automatically come away from the inside wall of the body cavity 30 of the chicken 5 under the influence of gravity. The finger 6 can then again be positioned such that the spray head 7 is in the body cavity 30. Rinsing agent is then sprayed with the aid of the spray head 7 into the interior of the chicken 5 to clean the inside wall of the body cavity 30. It is clear that in the embodiment according to FIG. 6 the finger 6 is arranged on the guide 8 such that it is movable essentially in the horizontal direction.

For the sake of clarity it is pointed out that the term skin/fat 20 in the present invention is used to refer to the essentially freely hanging skin/fat that remains behind on removal of the innards of the chicken from the body cavity thereof. It is clear that the term skin/fat is not an official anatomical term. It will, however, be clear to those skilled in the art what is intended by this term because such an amount of skin/fat that will cover at least a portion of the inside wall of the body cavity 30 will be present with every chicken or similar bird that is treated in the manner described above.

1. Method for rinsing the body cavity of slaughtered poultry, such as a slaughtered chicken, wherein, after removing the innards from the bird, a finger is inserted in the body cavity, rinsing agent is introduced via the finger into the body cavity for rinsing said body cavity and the finger is removed from the body cavity, characterised in that before and/or during rinsing of the body cavity the skin/fat between the legs of the bird, at the anal end of the body cavity, is moved away from the wall of the body cavity.

2. Method according to claim 1, characterised in that the bird is hung essentially vertically before the body cavity thereof is rinsed.

3. Method according to claim 1 or 2, characterised in that a member is moved in the body cavity underneath the skin/fat between the legs of the bird, after which the member is moved upwards over a distance such that the skin/fat is essentially moved away from the wall of the body cavity.

4. Method according to claim 3, characterised in that the member is fixed to the finger for introducing rinsing agent into the body cavity.

5. Method according to one of the preceding claims, characterised in that, before rinsing, the vertical position of the bird is adjusted by pushing the bird with the aid of a pusher.

6. Method according to one of claims 1-4, characterised in that the bird is rotated from an equilibrium position towards a first side in order to position a first portion of the skin/fat above the member and that the member is then lifted, after which the bird is rotated towards a second side in order to position a second portion of the skin/fat above the second member, after which the member is moved upwards.

7. Method according to one of the preceding claims, characterised in that after introducing the finger, the cross-section of essentially the end of the finger is allowed to increase in order to engage the bottom of the skin/fat, after which the finger is moved upwards somewhat, before and/or during rinsing of the body cavity, in order to move the skin/fat away from the wall of the body cavity.

8. Method according to one of claims 1 or 2, characterised in that, before and/or during rinsing, the skin/fat between the legs of the bird is moved away from the wall of the body cavity by rotating the bird from the essentially vertical position into an essentially horizontal position, the skin/fat coming away from the wall of the body cavity under the influence of gravity.

9. Method according to claim 8, characterised in that the bird is allowed to rotate into the horizontal position thereof, for example with the aid of a rail.

10. Apparatus for rinsing the body cavity of a slaughtered bird, such as a slaughtered chicken, provided with a transport device for moving the chicken, which transport device is provided with hooks for engaging the legs of the bird, and a finger that is provided with a spray head, which finger is suitable for inserting in the body cavity of the bird in order to rinse the body cavity of the bird by means of the spray head of the finger, characterised in that the apparatus comprises means for causing the skin/fat between the legs of the slaughtered bird, at the anal end of the body cavity thereof, to move away from the wall of the body cavity.

11. Apparatus according to claim 10, characterised in that the means for causing the skin/fat of the bird to move away from the wall of the body cavity comprise a member for engaging under the skin/fat of the bird and moving said skin/fat essentially in the vertical direction.

12. Apparatus according to claim 10 or 11, characterised in that the member for moving the skin/fat away from the wall of the body cavity is fixed to the finger for rinsing the body cavity.

13. Apparatus according to claims 10-12, characterised in that the member for engaging the skin/fat can be folded out from a first folded-up position into a second folded-out position, the cross-section of the member in the folded-out position being greater than that in the folded-up position thereof.

14. Apparatus according to one of claims 10-13, characterised in that the apparatus comprises a pusher for engaging on the outside wall of the bird for positioning the skin/fat above the member for moving the skin/fat.

15. Apparatus according to one of claims 10-14, characterised in that the apparatus comprises means for rotating the bird from an essentially vertical equilibrium position in order, by means of said rotation, to position, respectively, a first and a second portion of the skin/fat of the bird above the member.

16. Apparatus according to one of claims 10-14, characterised in that it is possible to move the member to position the member under, respectively, a first and a second portion of the skin/fat of the bird.

17. Apparatus according to one of claims 10-16, characterised in that the movement of the means for causing the skin/fat to move away from the wall of the body cavity are coupled to the transport device in such a way that the means are actuated during the transport of the bird by the device.
